(19) United States
(12) Patent Application Publication
(10) Pub. No.: US 2022/0028025 A1
(43) Pub. Date: Jan. 27, 2022

(54) INFORMATION PROCESSING APPARATUS, INFORMATION PROCESSING METHOD, AND NON-TRANSITORY STORAGE MEDIUM

(71) Applicant: Toyota Jidosha Kabushiki Kaisha, Toyota-shi Aichi-ken (JP)

(72) Inventor: Xin Jin, Nagoya-shi (JP)

(21) Appl. No.: 17/377,806

(22) Filed: Jul. 16, 2021

(30) Foreign Application Priority Data
Jul. 22, 2020 (JP) 2020-125814

(51) Int. Cl. G06Q 50/30; G06Q 30/02; B60R 16/023

(52) U.S. Cl. CPC G06Q 50/30; G06Q 2240/00; B60R 16/0231; G06Q 30/0284

(57) ABSTRACT

The present disclosure enables determining an appropriate dispatch point for a vehicle in a transportation system where a plurality of users is to board one vehicle. The present disclosure provides an information processing apparatus for managing operation of a vehicle that a plurality of users is to board together. The information processing apparatus including a controller performs a first process of acquiring a boarding request including a desired boarding point from at least one user who wants to board the vehicle, and a second process of grouping at least one boarding request into at least one group, and determining a boarding point of the vehicle for each group that is created.

### CROSS REFERENCE TO THE RELATED APPLICATION

This application claims the benefit of Japanese Patent Application No. 2020-125814, filed on Jul. 22, 2020, which is hereby incorporated by reference herein in its entirety.

### BACKGROUND

### Technical Field

The present disclosure relates to a technique for allowing a plurality of users to travel by boarding one vehicle.

### Description of the Related Art

A mode of a plurality of user traveling by sharing a ride on one vehicle (ridesharing) is becoming widespread mainly in countries outside Japan from the standpoint of alleviating traffic congestion and saving fuel bill, and for environmental measures, for example.

In relation to such circumstances, for example, Japanese Patent Laid-Open No. 2003-308596 discloses a system for dispatching a rideshare vehicle based on boarding requests acquired from a plurality of users.

In a case of small-scale transport, more efficient transportation may be performed by sending a vehicle on a per-demand basis than with a bus or the like with a fixed operation schedule.

[Patent document 1] Japanese Patent Laid-Open No. 2003-308596

### SUMMARY

In the case of dispatching a vehicle based on a request transmitted from a user, when all the requests are to be individually met, there is a problem that transportation efficiency is reduced.

The present disclosure has been made in view of the circumstances described above, and one or more aspects thereof are directed to determine an appropriate dispatch point for a vehicle in a transportation system where a plurality of users is to board one vehicle.

An information processing apparatus according to a first aspect of the present disclosure may be an information processing apparatus for managing operation of a vehicle that a plurality of users is to board together, the information processing apparatus including a controller including at least one processor configured to perform a first process of acquiring a boarding request including a desired boarding point from at least one user who wants to board the vehicle, and a second process of grouping at least one boarding request into at least one group, and determining a boarding point of the vehicle for each group that is created.

Furthermore, an information processing method according to a second aspect of the present disclosure may be an information processing method for managing operation of a vehicle that a plurality of users is to board together, the information processing method including: acquiring a boarding request including a desired boarding point from at least one user who wants to board the vehicle, and grouping at least one boarding request into at least one group, and determining a boarding point of the vehicle for each group that is created.

Furthermore, a third aspect of the present disclosure may be a non-transitory computer-readable storage medium storing a program for causing a computer to perform the information processing method described above.

According to the present disclosure, an appropriate dispatch point may be determined for a vehicle in a transportation system where a plurality of users is to board one vehicle.

### BRIEF DESCRIPTION OF THE DRAWINGS

FIG. 1 is a schematic configuration diagram of a transportation system according to a first embodiment;

FIG. 2A is a diagram for describing a relationship between desired boarding points and a boarding point;

FIG. 2B is another diagram for describing a relationship between desired boarding points and a boarding point;

FIG. 2C is another diagram for describing a relationship between desired boarding points and a boarding point;

FIG. 3 is a system configuration diagram of a user terminal 10 according to the first embodiment;

FIG. 4 is a diagram for describing a boarding request;

FIG. 5 is a system configuration diagram of a server device 20 according to the first embodiment;

FIG. 6 is a flowchart of a process that is performed by the server device in the first embodiment;

FIG. 7 is a diagram for describing grouping in space-time;

FIG. 8 is a flowchart of a process that is performed in step S12; and

FIG. 9 is a flowchart of a process that is performed by the server device in a second embodiment.

### DESCRIPTION OF THE EMBODIMENTS

An information processing apparatus according to a first aspect of the present disclosure may be an apparatus that creates, based on boarding requests from a plurality of users, an operation plan of a vehicle (a shared taxi) that the users are to board. For example, a boarding request includes a point where a user wants to board the vehicle, a desired boarding time, a destination and the like.

In a transportation system where a vehicle is operated according to a request, there is a problem that, when requests from all the users are individually met, transportation efficiency is reduced.

For example, in the case where there are three users who want to get on board at different points at times close to one another, a vehicle has to travel to three points. However, when desired boarding points of the users are shifted and the three are made to get on board at a same location, one stop will suffice.

Accordingly, the information processing apparatus according to the first aspect of the present disclosure may acquire the boarding request including the desired boarding point from at least one user who wants to board the vehicle, groups at least one boarding request into at least one group, and determines the boarding point of the vehicle for each group that is created.

By grouping a plurality of boarding requests and determining the boarding point of the vehicle for each group as described above, a plurality of users who individually transmitted the boarding request may be made to board the vehicle at one time, and transportation efficiency may be increased.

Furthermore, a controller may group the boarding request based on geographical density of the desired boarding point.

For example, a group may be preferentially created for a place where the desired boarding points are more densely present. Such a process may be performed by a density-based clustering method, for example.

Furthermore, the controller may determine whether an outlying point that is a geographical outlier is included as the desired boarding point included in the group that is created.

Furthermore, in a case where the outlying point is included as the desired boarding point included in the group that is created, the controller may determine the boarding point for each group while excluding the outlying point.

An outlying point is a desired boarding point that is a target of grouping but that is at a place relatively away from other desired boarding points. When the boarding point is determined taking such a point into account, all the other users may have to move from the desired boarding points to the boarding point because of one user. However, when the outlying point is excluded, only the user corresponding to the outlying point is made to bear a movement cost. That is, benefits may be optimized for all.

Furthermore, the controller may cause conditions for boarding the vehicle to be different between a first user who is a user associated with the outlying point and a second user who is a user other than the first user.

Furthermore, the controller may set a boarding fee for the first user to be lower than the boarding fee for the second user.

The first user can be said to be a user for whom a distance from the desired boarding point to the boarding point is relatively long. In this case, the first user may be motivated by financial incentives to participate in the same group as the second user, for example.

Furthermore, the controller may, after the grouping is completed, present the boarding fee that is calculated to the user, and fix a reservation.

By going through a phase of confirmation of the boarding fee, usability may be increased.

Furthermore, the controller may, after the grouping is completed, cause the first user to select between participation in a same group as the second user and creation of a new group.

According to such a configuration, a user may be allowed to select whether to participate in “a group that requires a low fee and a walk to the boarding point” or “a group that requires a high fee but allows boarding at a specified location”, for example.

Furthermore, in a case where a group allowing participation is already created at a time when the boarding request is received from the user, the controller may cause the user to select which group to participate in or whether to create a new group.

According to such a configuration, participation of a new user may be enabled after a group is created.

Hereinafter, specific embodiments of the present disclosure will be described with reference to the drawings. A hardware configuration, a module configuration, a structural configuration and the like described in each embodiment are not intended to limit the technical scope of the disclosure unless stated otherwise.

### First Embodiment

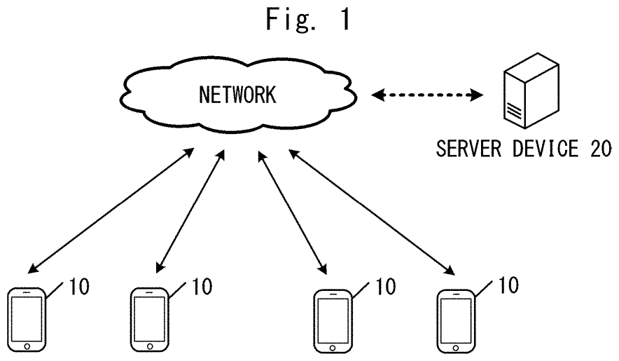

An outline of a transportation system according to a first embodiment is illustrated in FIG. 1. The transportation system according to the present embodiment includes a user terminal 10 that is associated with a user who is to board a shared taxi, and a server device 20 that manages operation of the shared taxi.

A shared taxi (hereinafter referred to simply as “vehicle”) is a transportation service that is operated according to a boarding request from a user.

A user who wants to board the vehicle transmits a boarding request to the server device 20 through the user terminal 10. For example, the boarding request includes a desired boarding point, a desired boarding time, a desired get-off point, and the like.

Such information may be created and transmitted by application software that is installed in the user terminal 10 and that is for using the transportation system, for example. However, such information does not necessarily have to be created using a mobile terminal, and may be created using any terminal (such as a smartphone, a mobile phone, a tablet terminal, a personal digital assistant, or a wearable computer) or a personal computer that can be connected to a network, for example.

The server device 20 creates an operation plan of the vehicle based on the boarding request transmitted from the user terminal 10. The operation plan includes a route that the vehicle is to travel, point and time of picking up the user, and the like, for example.

In the transportation system according to the present embodiment, each of a plurality of user terminals 10 and the server device 20 are mutually connected over a network. As the network, a wide area network (WAN), which is a worldwide public communication network such as the Internet, or other communication networks may be adopted, for example. The network may further include a mobile communication network for mobile phones or a wireless communication network such as Wi-Fi (registered trademark).

In a case where a plurality of requests expressing wishes to board the vehicle at a plurality of points that is close to each other and to travel in a same direction are received, the server device 20 according to the present embodiment reduces an operation cost by grouping the boarding requests.

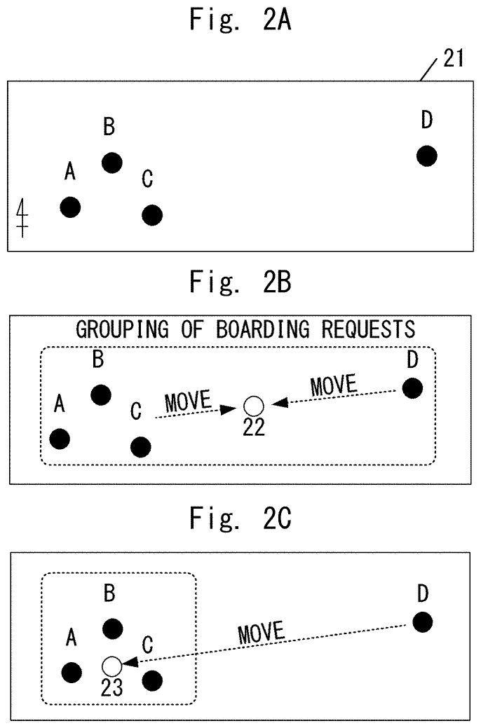

FIGS. 2A to 2C are diagrams illustrating a relationship between a plurality of boarding requests and a boarding point.

For example, as illustrated in FIG. 2A, it is assumed that there are four users (users A to D) who want to board the vehicle in an area (a reference sign 21). In the case where the desired boarding points of the users are dispersed as illustrated in the diagram, four points have to be covered to meet all the requests. However, as illustrated in FIG. 2B, when the plurality of boarding requests is grouped and the four users are made to get on board at a same boarding point (a reference sign 22), picking-up has to be performed just once.

However, when a plurality of boarding requests is grouped, there is a problem that, although the operation cost of the vehicle is reduced, costs on the users are increased. For example, in the case of grouping the four boarding requests and picking up the users at the boarding point 22, as illustrated in the drawing, the four users have to move to the boarding point 22. In the example in FIG. 2B, convenience is reduced for the users A to C because of the user D. In many cases, such movement is performed on foot, and when there is a movement distance, convenience of a transportation service is reduced, and users are possibly discouraged from using the transportation service.

In the present example, as a method of reducing the cost on the user, there is a method of ignoring a so-called “outlier”, as in FIG. 2C, for example. That is, the desired boarding point that is associated with the user D and that is evaluated to be a geographical outlier is excluded, and an actual boarding point (a reference sign 23) is set based only on the desired boarding points that are associated with the users A to C. In this case, the movement distance of the user D is increased, but the costs on the users A to C may be reduced.

Here, when a cost reduction effect is great even when taking into account a demerit of excluding the outlier (for example, an incentive to be paid to the user D), adopting the method as described above may bring total optimization closer.

The server device 20 according to the present embodiment overcomes the problem as described above by setting the boarding point for each group while taking a geographical outlier into account.

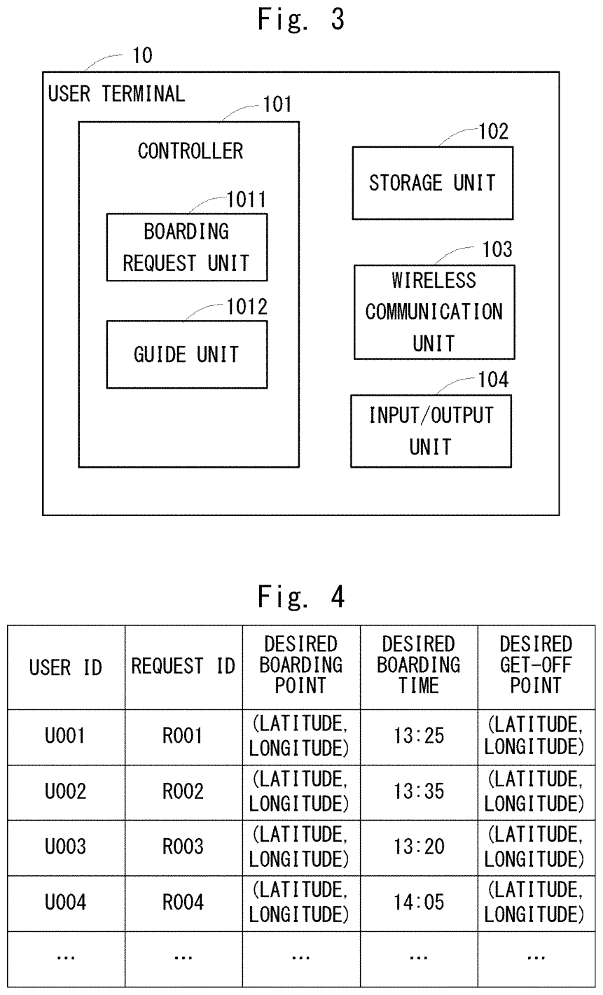

Next, a configuration of the user terminal 10 will be described. FIG. 3 is a diagram illustrating a system configuration of the user terminal 10.

For example, the user terminal 10 is a small computer such as a smartphone, a mobile phone, a tablet computer, a personal digital assistant, a laptop computer, or a wearable computer (such as a smartwatch). The user terminal 10 includes a controller 101, a storage unit 102, a wireless communication unit 103, and an input/output unit 104.

The controller 101 is a processing unit that is in charge of control that is performed by the user terminal 10. The controller 101 may be implemented by a processing unit such as a central processing unit (CPU).

The controller 101 includes two types of functional modules, that is, a boarding request unit 1011 and a guide unit 1012. Each functional module may be implemented by the CPU executing a program stored in the storage unit 102 described later.

The boarding request unit 1011 acquires, from the user, a request for making a boarding reservation for a vehicle, and transmits the same to the server device 20. Specifically, a user ID, the desired boarding point, the desired boarding time, the desired get-off point and the like are acquired through the input/output unit 104 described later. The acquired information is transmitted to the server device 20 as the boarding request. FIG. 4 is an example of the boarding request that is created. Furthermore, the boarding request unit 1011 communicates with the server device 20 and performs a process of fixing the boarding reservation.

After the boarding reservation is fixed, the guide unit 1012 presents, to the user, information about operation of the vehicle (hereinafter “operation information”) transmitted from the server device 20. The operation information is created by the server device 20 based on a plurality of boarding requests, and includes the boarding point of the vehicle, an arrival time of the vehicle, and the like.

The storage unit 102 includes a main memory and an auxiliary memory. The main memory is a memory where programs to be executed by the controller 101, and data to be used by the control programs are developed. The auxiliary memory is a unit that stores the programs to be executed by the controller 101, and the data to be used by the control programs. The auxiliary memory may store the programs to be executed by the controller 101 by packaging the same as applications. Furthermore, an operating system for executing the applications may also be stored. Processes described below are performed the programs stored in the auxiliary memory being loaded into the main memory and executed by the controller 101.

The main memory may include a random access memory (RAM) and a read only memory (ROM). The auxiliary memory may include an erasable programmable ROM (EPROM) and a hard disk drive (HDD). The auxiliary memory may further include a removable medium, that is, a removable recording medium. The removable medium is a universal serial bus (USB) memory or a disk recording medium such as a compact disc (CD) or a digital versatile disc (DVD), for example.

The wireless communication unit 103 is a wireless communication interface for connecting the user terminal 10 to the network. For example, the wireless communication unit 103 provides access to the network through a wireless LAN or a mobile communication service such as 3G or LTE.

The input/output unit 104 receives an input operation performed by the user, and presents information to the user. In the present embodiment, the input/output unit 104 includes one touch panel display. That is, the input/output unit 104 includes a liquid crystal display and a control thereof, and a touch panel and a control thereof.

The configuration illustrated in FIG. 3 is merely an example, and one or some or all of the functions illustrated may be implemented using a dedicated circuit. Furthermore, programs may be stored and executed by a combination of a main memory and an auxiliary memory other than those illustrated.

Next, a configuration of the server device 20 will be described.

The server device 20 may be a general-purpose computer. That is, the server device 20 may be a computer that includes processors such as a CPU and a GPU, main memories such as a RAM and a ROM, and auxiliary memories such as an EPROM, a hard disk drive and a removable medium. Additionally, the removable medium may be an USB memory or a disk recording medium such as a CD or a DVD, for example. The auxiliary memory stores an operating system (OS), various programs, various tables and the like, and a function matching a predetermined object as described below may be implemented through execution of a program that is stored therein. However, one or some or all of the functions may alternatively be implemented by a hardware circuit such as an ASIC or an FPGA. The server device 20 may be a single computer, or may include a plurality of computers that is coordinated with each other.

FIG. 5 is a diagram illustrating a system configuration of the server device 20. The server device 20 includes a controller 201, a storage unit 202, and a communication unit 203.

The controller 201 is a processing unit that is in charge of control that is performed by the server device 20. The controller 201 may be implemented by a processing unit such as a CPU.

The controller 201 includes two types of functional modules, that is, a boarding request acquisition unit 2011 and a vehicle-dispatch-plan creation unit 2012. Each functional module may be implemented by the CPU executing a program stored in an auxiliary storage.

The boarding request acquisition unit 2011 acquires the boarding requests from a plurality of user terminals 10, and causes the same to be temporarily stored in the storage unit 202. The boarding requests that are acquired and stored are used by the vehicle-dispatch-plan creation unit 2012.

The vehicle-dispatch-plan creation unit 2012 creates an operation plan of a vehicle based on a plurality of boarding requests that is collected. Specifically, a process of grouping a plurality of boarding requests with close desired boarding points and close desired boarding times, and a process of creating an operation plan of a vehicle based on the result of grouping are performed. Details of the processes will be given later.

The storage unit 202 includes a main memory and an auxiliary memory. The main memory is a memory where programs to be executed by the controller 201, and data to be used by the control programs are developed. The auxiliary memory is a unit that stores the programs to be executed by the controller 201, and the data to be used by the control programs. The main memory and the auxiliary memory are the same as those of the storage unit 102, and a detailed description thereof will be omitted.

The communication unit 203 is a communication interface for connecting the server device 20 to the network. For example, the communication unit 203 includes a network interface board, and a wireless communication circuit for wireless communication.

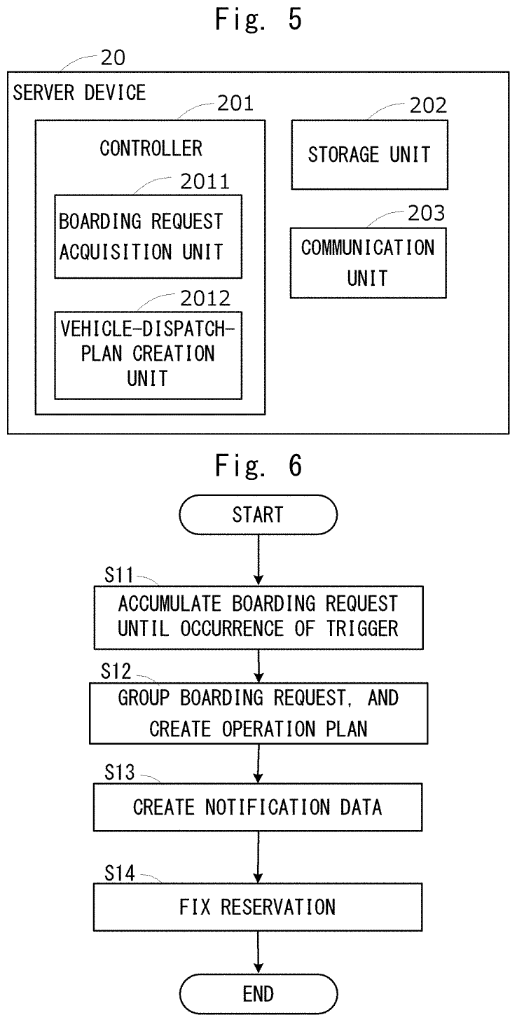

Next, details of a process performed by the controller 201 will be given with reference to the flowchart illustrated in FIG. 6. The illustrated process is performed every predetermined period of time.

First, in step S11, the boarding request acquisition unit 2011 acquires the boarding request from each of a plurality of user terminals 10. The user terminal 10 is allowed to transmit the boarding request by a predetermined deadline time (such as 30 minutes before the desired boarding time), for example.

The acquired boarding requests are accumulated until occurrence of a predetermined trigger. The trigger may be caused to occur every predetermined period of time (such as every 10 minutes), or may be caused to occur at a specified time.

When the predetermined trigger occurs, the process proceeds to step S12.

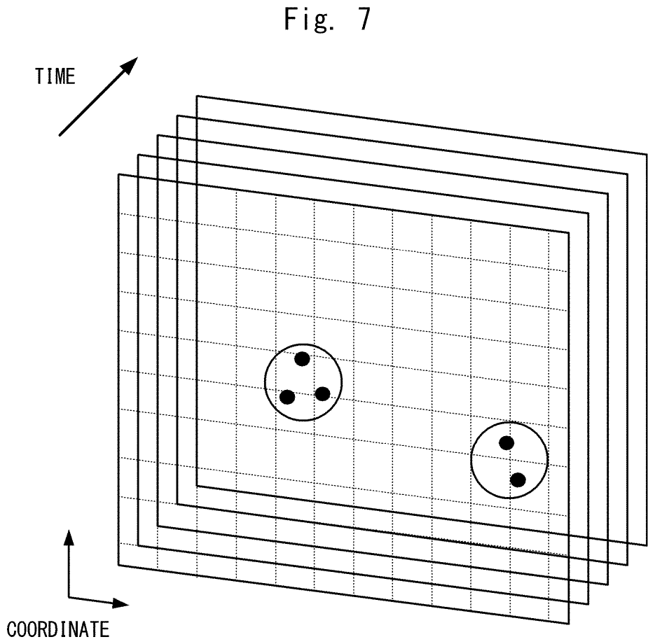

In step S12, first, the vehicle-dispatch-plan creation unit 2012 performs a process of grouping at least one boarding request. For example, as illustrated in FIG. 7, points corresponding to the boarding requests are plotted in a space including coordinates on X-axis and Y-axis and time on Z-axis, and these points plotted in a space-time are grouped by a predetermined method. As the predetermined method, a clustering method such as k-means may be typically adopted, but any method may be adopted as long as a plurality of values may be grouped. In the case of adopting the clustering method for grouping, the density-based clustering method may be adopted, for example.

Furthermore, in the case of using methods other than clustering, a group may be created such that predetermined conditions are satisfied. The predetermined conditions may be that “a plurality of boarding requests whose desired boarding points are within a predetermined distance (such as within 500 meters) are grouped”, and that “a plurality of boarding requests whose desired boarding times are within a predetermined range (such as within 15 minutes) are grouped”, for example.

Next, the vehicle-dispatch-plan creation unit 2012 determines the boarding point and the boarding time for the group according to a predetermined rule.

Next, the vehicle-dispatch-plan creation unit 2012 creates an operation plan of a vehicle. The boarding point and the boarding time for each group are determined, or in other words, points in the space-time are set, by the process described above, and thus, an operation plan is created such that a vehicle travels through the points. An operation plan of a vehicle that covers a plurality of boarding points is thus created. Additionally, in the case where one vehicle cannot pick up all the users, or in the case where it is not desirable to pick up all the users by one vehicle, a vehicle may be added and same processes may be performed. The number of vehicles to be operated, and the operation plan of each vehicle are thus determined.

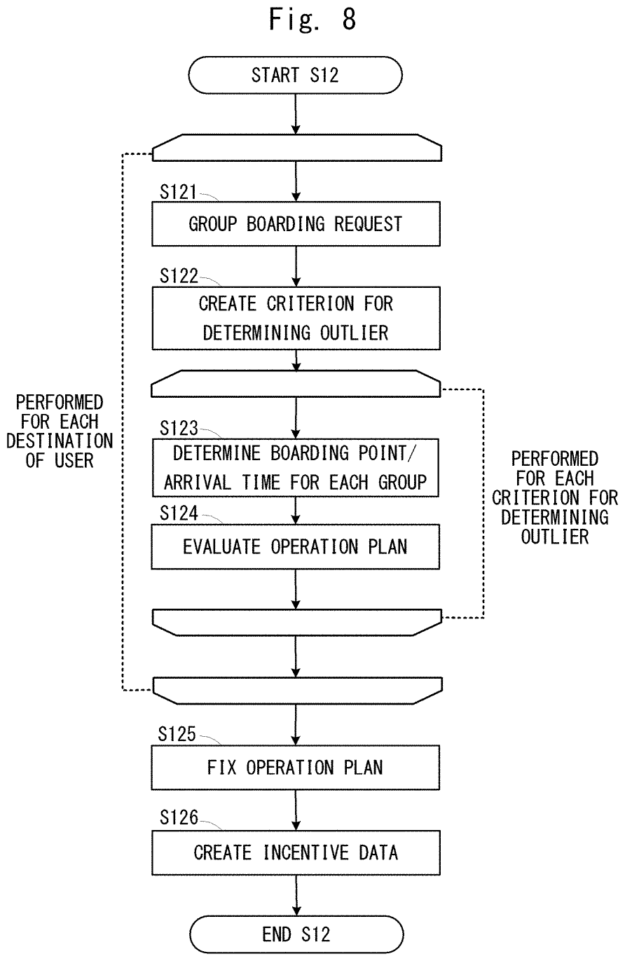

Now, the process that is performed in step S12 will be described in greater detail with reference to the flowchart in FIG. 8.

First, in step S121, at least one boarding request plotted in the space-time is grouped using a predetermined parameter. As described above, grouping may be performed by the clustering method.

For example, in the case of performing density-based clustering, a parameter that specifies the density may be used. Moreover, in the case of simply grouping a plurality of boarding requests whose desired boarding points are within a predetermined distance, a parameter that specifies the distance may be used.

Next, in step S122, a criterion for determining the outlier is created. For example, the criterion for determining the outlier is that “a desired boarding point that is away from a center of gravity of a plurality of desired boarding points by a predetermined distance or more is treated as an outlier”. In the present embodiment, a plurality of predetermined distances is created (such as 500 m, 750 m, and 1 km), steps S123 and S124 are repeatedly performed, and results are evaluated.

In step S123, the boarding point and the arrival time for each group are determined. The boarding point for a group may be determined by the following methods, for example. In each case, calculation is performed by excluding a desired boarding point that is evaluated to be an outlier.

(1) A Middle Point of Desired Boarding Points Farthest from Each Other

This is a method of taking

P_{boarding point}=(P₁+P₂)/2

as the boarding point, where the desired boarding points that are farthest from each other are given as P₁ and P₂.

### (2) A Weighted Average of Desired Boarding Points Calculated Using the Number of Users

This is a method of taking

P_{boarding point}=(P₁U₂+P₂U₂+ . . . +PₙUₙ)/(U₁+U₂+ . . . +Uₙ)

as the boarding point, where the number of users who want to get on board at points P₁, . . . , Pₙ are U₁, . . . , Uₙ, respectively.
(3) A Desired Boarding Point with the Largest Number of People

This is a method of taking the desired boarding point with the largest number of users as the boarding point, in a case where a plurality of boarding requests includes a same (or substantially same) desired boarding point.

Other methods may also be adopted. Moreover, the arrival time may also be determined in the same manner as for the boarding point (the method of excluding the outlier).

Next, in step S124, the operation plan of the vehicle is created and evaluated. Evaluation of the operation plan may be performed based on income and expenditure calculated based on (1) cost of operating the vehicle, and (2) revenue from transportation (boarding fee).

The cost includes an operation cost of the vehicle and a cost borne by the user (hereinafter “user cost”). For example, the user cost takes a value obtained by accumulating the movement distance between the desired boarding point and the actual boarding point of each user.

For example, the boarding fee may be determined based on the number of users who are to board the same vehicle at the same point or the total number of users who are to board the same vehicle.

For example, in the case where the operation cost is 3,000 yen for one operation, and six people are to board at the same point, the boarding fee may be set to 500 yen per person. Additionally, in the case where the boarding fee is to be determined based on the total number of users who are to board the same vehicle, the boarding fee may be adjusted based on a boarding distance. In either case, the boarding fee per person may be set lower, the greater the number of users who are to board the same vehicle at the same point or the greater the total number of users who are to board the same vehicle. The boarding fee for the vehicle may alternatively be calculated based on a mathematical formula or a table that is stored in advance.

Additionally, in the case of giving an incentive to a user corresponding to the outlier, the incentive may be subtracted from the boarding fee.

The processes in steps S123 and S124 are performed for each of a plurality of determination criteria created in step S122.

Furthermore, the processes in steps S121 to S124 are performed for each destination of users (or each direction the users are heading). This is because, when users with different destinations or users who are heading in different directions board the same vehicle, a travel distance or a boarding time is increased, and a total cost is increased.

In step S125, a pattern that is to be finally adopted is determined based on an evaluation result acquired for each criterion for determining the outlier and for each destination of users. For example, a most profitable pattern may be selected for each destination of users.

Furthermore, in the present step, a pattern not satisfying a predetermined condition may be excluded. For example, an inappropriate pattern where the number of users exceeds a seating capacity of the vehicle (that is, a case where operation of the vehicle is not possible) may be excluded.

An operation plan of the vehicle is fixed by the processes described above.

Next, in step S126, incentive data indicating an incentive to be given to a user corresponding to an outlier is created. For example, in the case where there is a criterion “50 yen is subtracted from the boarding fee for every 100 m walk”, when a user corresponding to an outlier needs to move 500 m, the amount of incentive is 250 yen. The incentive data is transmitted to an external system that charges the boarding fee, for example.

A description will be further given by referring back to FIG. 6.

When an operation plan of the vehicle is determined, the vehicle-dispatch-plan creation unit 2012 creates notification data in step S13. The notification data is data for notifying the user of the boarding point (and the arrival time) that is fixed and the boarding fee.

The notification data is transmitted to the user terminal 10, and a boarding reservation is fixed upon acceptance by the user (step S14). The server device 20 dispatches the vehicle based on the boarding reservation that is fixed. For example, in the case where the vehicle is a manually driven vehicle, the server device 20 creates data for notifying a driver of an operation time. In the case where the vehicle is an autonomous vehicle, the server device 20 creates a travel command to the vehicle.

Furthermore, the server device 20 transmits operation information of the vehicle to the user terminal 10. The operation information is presented to the user by the guide unit 1012.

As described above, in the case where there is a plurality of users who can board the same vehicle, the transportation system according to the first embodiment groups the plurality of users. Furthermore, the boarding point of the vehicle is determined for each group by taking into account a geographical outlier.

According to such a configuration, the operation cost of a vehicle may be reduced while preventing convenience of the users from being reduced as much as possible.

(Example Modification of First Embodiment)

In the first embodiment, the boarding requests are accumulated in step S11 until occurrence of a predetermined trigger, but when the user wants, the process of creating a group in step S12 may be omitted, and a group may be instantly established. In this case, the number of users in the group is one, and the boarding fee is possibly higher compared with a case where a plurality of people boards the vehicle at the same time, but boarding can definitely be performed at a desired point.

Furthermore, in the first embodiment, the user is asked in step S14 whether the notification data is acceptable. In the case where the user does not accept the notification data, the corresponding boarding request may be put to a wait state again, and grouping may be performed again. This enables a demand to “wait until a larger number of people are gathered, because the boarding fee is high” to be met, for example.

### Second Embodiment

With the transportation system according to the first embodiment, a case is conceivable where a boarding request is transmitted from a new user after a group is created. However, it is not practical to re-create a group every time a boarding request is received.

A second embodiment is an embodiment according to which, to cope with such a situation, a new boarding request is accepted after a group is created.

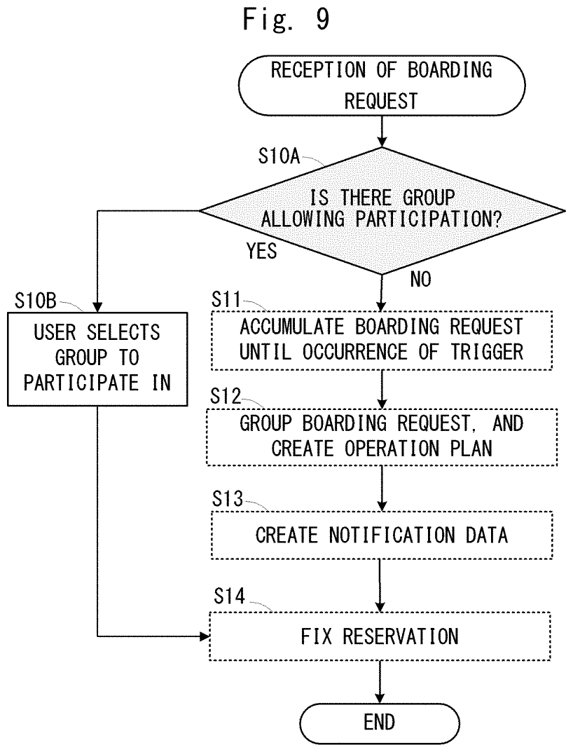

FIG. 9 is a flowchart of a process that is performed by the server device 20 in the second embodiment.

In the second embodiment, when a boarding request is received from the user terminal 10, it is determined in step S10A whether there is a group allowing participation, or more specifically, a group that satisfies the following conditions. (1) A group with respect to which a difference between the desired boarding time included in the boarding request and the arrival time of the vehicle is within a predetermined value. (2) A group with respect to which a distance between the desired boarding point included in the boarding request and the boarding point is within a predetermined value.

In the case where there is at least one group that satisfies the conditions, the process proceeds to step S10B.

In step S10B, data for inquiring whether to participate in the group (or which group to participate in, in a case where there are a plurality of groups) is transmitted to the user terminal 10, and a choice of the user is acquired. The data includes the boarding point and the boarding fee of the vehicle for each group. Then, in step S14, a reservation is fixed based on the choice of the user.

When the boarding point and the boarding fee for each group are presented, the user may be provided with options such as “a group with a remote boarding point that requires a low fee and a walk” and “a group that requires a high fee but allows boarding at a desired point”, for example.

Additionally, in step S10B, an option “create a new group” may be provided to the user instead of allowing selection of a group to participate in. In the case where the user wants a new group to be created, a group including only the user in question may be newly created. In this case, the number of users in the group is one, and the boarding fee is higher compared with a case where a plurality of people boards the vehicle at the same time, but boarding can definitely be performed at a desired point.

In the case where there is no group that satisfies the conditions in step S10A, the process proceeds to step S11. That is, as in the first embodiment, occurrence of a trigger is waited for, and a new group is then created. Additionally, as in the example modification of the first embodiment, when the user wants, the process of creating a group in step S12 may be omitted, and a group may be instantly established.

According to the second embodiment, a new boarding request may be accepted even in a state where a group is already created.

### EXAMPLE MODIFICATIONS

The embodiments described above are merely examples, and the present disclosure may be changed as appropriate within the scope of the disclosure.

For example, the processes and means described in the present disclosure may be freely combined to the extent that no technical conflict occurs.

For example, in the case where there is an outlier among the desired boarding points included in a group that is created, grouping may be performed again to create a group including only the outlier. For example, in the case of the example in FIGS. 2A to 2C, two groups, namely, a group for the users A to C and a group for the user D, may be created. Depending on the result of comparing an amount of increase in the cost due to an increased number of times of picking up a user and an incentive to be given to a user, it is sometimes better to increase the number of groups (that is, the number of times of picking up).

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the above embodiments to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus for managing operation of a vehicle that a plurality of users is to board together, the information processing apparatus comprising a controller including at least one processor configured to perform:
a first process of acquiring a boarding request including a desired boarding point from at least one user who wants to board the vehicle; and
a second process of grouping at least one boarding request into at least one group, and determining a boarding point of the vehicle for each group that is created.

2. The information processing apparatus according to claim 1, wherein the controller groups the boarding request based on geographical density of the desired boarding point.

3. The information processing apparatus according to claim 1, wherein the controller determines whether an outlying point that is a geographical outlier is included as the desired boarding point included in the group that is created.

4. The information processing apparatus according to claim 3, wherein, in a case where the outlying point is included as the desired boarding point included in the group that is created, the controller determines the boarding point for each group while excluding the outlying point.

5. The information processing apparatus according to claim 4, wherein the controller causes conditions for boarding the vehicle to be different between a first user who is a user associated with the outlying point and a second user who is a user other than the first user.

6. The information processing apparatus according to claim 5, wherein the controller sets a boarding fee for the first user to be lower than the boarding fee for the second user.

7. The information processing apparatus according to claim 6, wherein, after the grouping is completed, the controller presents the boarding fee that is calculated to the user, and fixes a reservation.

8. The information processing apparatus according to claim 5, wherein, after the grouping is completed, the controller causes the first user to select between participation in a same group as the second user and creation of a new group.

9. The information processing apparatus according to claim 1, wherein, in a case where a group allowing participation is already created at a time when the boarding request is received from the user, the controller causes the user to select which group to participate in.

10. The information processing apparatus according to claim 1, wherein, in a case where a group allowing participation is already created at a time when the boarding request is received from the user, the controller causes the user to select which group to participate in or whether to create a new group.

11. An information processing method managing operation of a vehicle that a plurality of users is to board together, the information processing method comprising:
acquiring a boarding request including a desired boarding point from at least one user who wants to board the vehicle; and
grouping at least one boarding request into at least one group, and determining a boarding point of the vehicle for each group that is created.

12. The information processing method according to claim 11, wherein the boarding request is grouped based on geographical density of the desired boarding point.

13. The information processing method according to claim 11, further comprising determining whether an outlying point that is a geographical outlier is included as the desired boarding point included in the group that is created.

14. The information processing method according to claim 13, wherein, in a case where the outlying point is included as the desired boarding point included in the group that is created, the boarding point for each group is determined while excluding the outlying point.

15. The information processing method according to claim 14, wherein conditions for boarding the vehicle are made different between a first user who is a user associated with the outlying point and a second user who is a user other than the first user.

16. The information processing method according to claim 15, wherein a boarding fee for the first user is set to be lower than the boarding fee for the second user.

17. The information processing method according to claim 16, wherein, after the grouping is completed, the boarding fee that is calculated is presented to the user, and a reservation is fixed.

18. The information processing method according to claim 15, wherein, after the grouping is completed, the first user is made to select between participation in a same group as the second user and creation of a new group.

19. The information processing method according to claim 11, wherein, in a case where a group allowing participation is already created at a time when the boarding request is received from the user, the user is made to select which group to participate in or whether to create a new group.

20. A non-transitory storage medium recording a program for causing a computer to perform the information processing method according to claim 11.
